(19) United States
(12) Patent Application Publication
(10) Pub. No.: US 2002/0040926 A1
(43) Pub. Date: Apr. 11, 2002

(54) Authentication method for surveillance devices

(76) Inventor: Gerhard Bock, Krailling (DE)

Correspondence Address: LERNER AND GREENBERG, P.A., Post Office Box 2480, Hollywood, FL, 33022-2480, US

(21) Appl. No.: 09/992,983

(22) Filed: Nov. 14, 2001

Related U.S. Application Data
(63) Continuation of application No. PCT/DE99/01463, filed on May 14, 1999.

(51) Int. Cl. G06K 5/00

(52) U.S. Cl. 235/382

(57) ABSTRACT

An authentication method for a surveillance device which has a camera, such as a videophone, includes the step of using a code sheet for entering an authentication code via the camera.

### CROSS-REFERENCE TO RELATED APPLICATION

This application is a continuation of copending International Application No. PCT/DE99/01463, filed May 14, 1999, which designated the United States.

### BACKGROUND OF THE INVENTION

### Filed of the Invention

The invention relates to an authentication method for a surveillance device.

Surveillance devices are used for example for guarding areas or rooms. Such surveillance devices may also be used as access control for checking the access authorization of persons entering a room or an area. A surveillance system or access system has a camera for providing an optical control in the visible or infrared wavelength range.

Such surveillance devices may also be implemented by using videophones. Stationary devices as well as mobile videophones, known as video cellphones, are used for this purpose.

An authorized user will provide authentication for himself or herself to the surveillance device. The surveillance device serves in particular as access authorization to electronic services or as access authorization to areas kept under surveillance by the camera.

Chip cards are used for example for an authentication, wherein a reader assigned to the surveillance device evaluates the chip cards. In the case of the videophone, the reader may, for example, be integrated in the videophone itself. In any event, for authentication it is necessary to directly handle the device or perform an action directly at the device, preferably at the reader. In the case of alarm systems, there are also solutions which use transponders which can be carried in a pocket. These systems share the common feature that a special hardware component is required for the authentication.

U.S. Pat. No. 4,958,064 discloses a method of checking an access authorization using a barcode reading device. The barcode is located on a card behind the windshield of a vehicle and is optically sensed through the use of a video camera. Since the camera is located at a relatively great distance from the car, and consequently from the barcode, additional contrast elements are provided on the card in a pattern which does not occur in nature. The contrast elements allow the card or the barcode to be located more easily and the camera to be correspondingly aligned.

Patents Abstracts of Japan Vol. 1995, No. 01, Feb. 28, 1995, JP 06 303615 A discloses an electronic locking system. A secret card with a barcode is used for control. The card is in this case held right in front of a camera and illuminated with infrared light.

### SUMMARY OF THE INVENTION

It is accordingly an object of the invention to provide an authentication method for a surveillance device which overcomes the above-mentioned disadvantages of the heretofore-known methods of this general type and which simplifies the authentication for a user.

With the foregoing and other objects in view there is provided, in accordance with the invention, an authentication method for a surveillance device, the method includes the steps of:

providing a surveillance device having a camera;

providing a code sheet having geometrical patterns for a coding; and

using the code sheet for a remote entry of an authentication code via the camera.

With the objects of the invention in view there is also provided, an authentication method for a surveillance device, including the steps of:

providing a surveillance device having a camera;

providing a code sheet having colors for a coding; and

using the code sheet for a remote entry of an authentication code via the camera.

According to another mode of the invention, a videophone or picture telephone is used as the camera.

Other features which are considered as characteristic for the invention are set forth in the appended claims.

Although the invention is described herein as embodied in an authentication method for surveillance devices, it is nevertheless not intended to be limited to the described details, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

An exemplary embodiment of the method according to the invention is described below. The invention is based on a surveillance device which has a camera. This surveillance device may be provided, for example, by a videophone (video telephone) also called picture telephone. Correspondingly configured videophones may be switched to a surveillance mode in which an optical area surveillance is carried out.

For switching off or deactivating the surveillance, an operator must provide authentication for himself or herself to the system.

According to the invention, a so-called code sheet is used for authentication. For optical authentication, the code sheet has characters and/or geometrical patterns. In the simplest case, for example, colored dots may be used, which are applied to the code sheet in a specific configuration or layout. The form and/or color, or a combination of the two, form the authentication code here. The code sheet may also have a pattern of lines, similar to what is known as a barcode.

If, for example, the videophone is used for area surveillance, the surveillance device can be disarmed or disabled by presenting the code sheet. If the videophone is used as an access control to electronic services, the corresponding service is enabled in an analogous way by presenting the code sheet.

The code sheet may be implemented in various forms and colors, for example as a pale or light colored box with dark areas provided in a specific configuration or placement, or else with differently colored dots. In this case, both the placement and the color can serve for the coding.

When the method according to the invention is used for authentication, no additional costs are incurred. Furthermore, the operator does not have to go up to the device being used for surveillance. The evaluation of the camera information and the comparison of the code sheet shown with a stored pattern takes place through the use of the same powerful microprocessor that is already implemented in the device in any case.

I claim:

1. An authentication method for a surveillance device, the method which comprises:
providing a surveillance device having a camera;
providing a code sheet having geometrical patterns for a coding; and
using the code sheet for a remote entry of an authentication code via the camera.

2. The method according to claim 1, which comprises using a videophone as the camera.

3. An authentication method for a surveillance device, the method which comprises:
providing a surveillance device having a camera;
providing a code sheet having colors for a coding; and
using the code sheet for a remote entry of an authentication code via the camera.

4. The method according to claim 3, which comprises using a videophone as the camera.
